(19) United States
(12) Patent Application Publication
(10) Pub. No.: US 2025/0108873 A1
(43) Pub. Date: Apr. 3, 2025

(54) DEVICE FIXING BRACKET AND VEHICLE

(71) Applicant: Guangzhou Tufa network technology Co., LTD, Guangzhou (CN)

(72) Inventors: Xiajun WANG, Guangzhou (CN); Yi SHI, Guangzhou (CN)

(73) Assignee: Guangzhou Tufa network technology Co., LTD, Guangzhou (CN)

(21) Appl. No.: 18/969,170

(22) Filed: Dec. 4, 2024

Related U.S. Application Data
(63) Continuation of application No. PCT/CN2024/105106, filed on Jul. 12, 2024.

(30) Foreign Application Priority Data
Oct. 1, 2023 (CN) 202322680435.2
Apr. 8, 2024 (CN) 202420705316.X

(51) Int. Cl. B62J 11/00

(52) U.S. Cl. CPC B62J 11/00

(57) ABSTRACT

This disclosure provides a device fixing bracket and a vehicle, including a first member, a second member, a first clamping portion, a second clamping portion, and a pull-back structure. The first member and the second member are constructed to be capable of moving toward or moving away from each other along a target direction. When the device fixing bracket is in operation, the second clamping portion and the first clamping portion clamp a target device under a pull-back force. When the device fixing bracket is not in operation, at least a part of the second member is covered by the first member under the pull-back force. The device fixing bracket in this disclosure is small in size, and convenient and safe to use.

### RELATED APPLICATIONS

This application is a continuation application of PCT application No. PCT/CN2024/105106, filed on Jul. 12, 2024, which claims the benefit of priority of Chinese application numbers CN 2023226804352 filed on Oct. 1, 2023, and CN 202420705316X filed on Apr. 8, 2024, and the contents of the foregoing documents are incorporated herein by reference in entirety.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

This disclosure relates to the field of vehicle technologies, and in particular, to a device fixing bracket and a vehicle.

### BACKGROUND

With development of science and technology, various vehicles have appeared in people's lives, bringing great convenience to people's lives. In particular, short-distance vehicles, such as kick scooters, tricycles, and self-balancing scooters, are increasingly used. People can drive vehicles while standing. The vehicles are small and light, suitable for traveling in narrow space, and have great advantages in ultra-short-distance travel. Currently, when traveling, people usually need to use electronic devices (such as mobile phones) for navigation or use cameras to record driving processes. Therefore, device fixing brackets are needed to fix the required devices. A device fixing bracket in the related art is usually mounted on a handlebar of a vehicle and protrudes from the handlebar. The device fixing bracket is large in size and not appealing. When used, the device fixing bracket needs to be opened and closed manually, which is inconvenient and may also cause safety hazards.

Therefore, a more appealing, more convenient, and safer device fixing bracket needs to be provided.

Content of the background section is only information known to the applicant personally, and neither represents that the information has entered the public domain before the filing date of the present disclosure, nor represents that it can become the prior art of the present disclosure.

### SUMMARY

The present disclosure provides a device fixing bracket to resolve problems existing in the related art.

According to a first aspect, this disclosure provides a device fixing bracket for fixing a target device, including: a first member; a second member, where the first member and the second member are configured to move toward or move away from each other along a target direction; a first clamping portion, connected to the first member; a second clamping portion, connected to the second member and disposed opposite to the first clamping portion along the target direction; and a pull-back structure, connected between the first member and the second member to enable the second clamping portion and the first clamping portion to move toward each other under a pull-back force of the pull-back structure, where when the device fixing bracket is in operation, the second clamping portion and the first clamping portion clamp the target device under the pull-back force, or when the device fixing bracket is not in operation, at least a part of the second member is covered by the first member under the pull-back force.

According to a second aspect, this disclosure provides a vehicle, including: a vehicle body, including a handlebar; and the device fixing bracket, including: a first member, a second member, where the first member and the second member are configured to move toward or move away from each other along a target direction, a first clamping portion, connected to the first member, a second clamping portion, connected to the second member and disposed opposite to the first clamping portion along the target direction, and a pull-back structure, connected between the first member and the second member to enable the second clamping portion and the first clamping portion to move toward each other under a pull-back force of the pull-back structure, where when the device fixing bracket is in operation, the second clamping portion and the first clamping portion clamp the target device under the pull-back force, or when the device fixing bracket is not in operation, at least a part of the second member is covered by the first member under the pull-back force, where the first member is mounted in a housing on the handlebar.

The device fixing bracket provided in this disclosure includes the first member and the second member, and the first member and the second member can move toward or move away from each other along the target direction. In addition, the first clamping portion is connected to the first member and the second clamping portion is connected to the second member, so that when the first member and the second member move relative to each other, the first clamping portion and the second clamping portion also move toward or move away from each other, thereby achieving an objective of clamping the target device. In this case, in combination with the pull-back structure, the pull-back force provided by the pull-back structure can achieve an objective of stably clamping the target device, so that the first clamping portion and the second clamping portion can autonomously clamp the target device to facilitate use. In addition, based on the pull-back force, when the device fixing bracket does not need to clamp the target device, at least a part of the second member is covered by the first member, and the second member and the first member can share at least a part of space, so that a total volume of space occupied by the two members is reduced, thereby reducing a volume of the device fixing bracket, and improving safety while improving aesthetics.

The device fixing bracket provided in this disclosure establishes a pair of active mechanisms capable of relative movement and a pair of passive mechanisms capable of relative movement driven by the active mechanisms. The active mechanisms include the first member and the second member. The passive mechanisms include the first clamping portion and the second clamping portion. The passive mechanisms also serve as clamping mechanisms for the target device, and then the pull-back structure capable of driving the first member and the second member to move toward each other in a free state is disposed, so that the device fixing bracket can autonomously clamp the target device and is convenient to use. In addition, the pull-back structure can make at least a part of the second member covered by the first member, thereby achieving an objective of reducing the volume of the device fixing bracket.

The vehicle provided in this disclosure includes the vehicle body and the device fixing bracket. The device fixing bracket is mounted in the housing on the handlebar. Therefore, the retracted device fixing bracket can be hidden in the housing on the handlebar. This further improves aesthetics and safety of the vehicle.

Other functions of the device fixing bracket and the vehicle provided in this disclosure are partially listed in the following description. Based on the description, content described in the following figures and examples is obvious to a person of ordinary skill in the art. Creative aspects of the device fixing bracket and the vehicle provided in this disclosure may be fully explained by practicing or using the method, apparatus, and a combination thereof provided in the following detailed examples.

### BRIEF DESCRIPTION OF THE DRAWINGS

In order to clearly illustrate the technical solutions of the embodiments of the present disclosure, the following will briefly introduce the drawings for the description of some exemplary embodiments. Apparently, the accompanying drawings in the following description are some exemplary embodiments of the present disclosure. For a person of ordinary skill in the art, other drawings may also be obtained based on these drawings without creative efforts.

FIG. 1 is an oblique view of a device fixing bracket in an open state according to some exemplary embodiments of this disclosure;

FIG. 2 is a front view of a device fixing bracket in a retracted state according to some exemplary embodiments of this disclosure;

FIG. 3 is a front view of a device fixing bracket in an open state according to some exemplary embodiments of this disclosure;

FIG. 4 is a sectional view A-A according to FIG. 3;

FIG. 5 is a left view of a device fixing bracket in an open state according to some exemplary embodiments of this disclosure;

FIG. 6 is a schematic structural diagram of a device fixing bracket on a handlebar in an open state according to some exemplary embodiments of this disclosure; and

FIG. 7 is a schematic structural diagram of a device fixing bracket on a handlebar in a retracted state according to some exemplary embodiments of this disclosure.

### DETAILED DESCRIPTION

The following description provides specific application scenarios and requirements of this disclosure, to enable a person skilled in the art to make and use content of this disclosure. Various partial modifications to the disclosed embodiments are obvious to a person skilled in the art. General principles defined herein can be applied to other embodiments and applications without departing from the spirit and scope of this disclosure. Therefore, this disclosure is not limited to the illustrated embodiments, but is to be accorded the widest scope consistent with the claims.

The terms used herein are only intended to describe specific exemplary embodiments and are not restrictive. For example, as used herein, singular forms “a”, “an”, and “the” may also include plural forms, unless otherwise clearly specified in a context. When used in this disclosure, the terms “comprise”, “include”, and/or “contain” indicate presence of associated features, integers, steps, operations, elements, and/or components, but do not preclude presence of one or more other features, integers, steps, operations, elements, components, and/or groups or addition of other features, integers, steps, operations, elements, components, and/or groups to the system/method.

In view of the following description, these features and other features of this disclosure, operations and functions of related elements of structures, and economic efficiency in combining and manufacturing components can be significantly improved. All of these form a part of this disclosure with reference to the drawings. However, it should be clearly understood that the drawings are only for illustration and description purposes and are not intended to limit the scope of this disclosure. It should also be understood that the drawings are not drawn to scale.

Flowcharts used in this disclosure show operations implemented by the system according to some exemplary embodiments of this disclosure. It should be clearly understood that operations in the flowcharts may be implemented out of order. Conversely, the operations may be implemented in a reverse order or simultaneously. In addition, one or more other operations may be added to the flowcharts, and one or more operations may be removed from the flowcharts.

In this disclosure, “X includes at least one of A, B, or C” means: X includes at least A, or X includes at least B, or X includes at least C. In other words, X may only include any one of A, B, and C, or may include any combination of A, B, and C, and other possible content or elements. Any combination of A, B, and C may be A, B, C, AB, AC, BC, or ABC.

In this disclosure, unless explicitly stated otherwise, an association relationship between structures may be a direct association relationship or an indirect association relationship. For example, in the description of “A is connected to B”, unless it is explicitly stated that A is directly connected to B, it should be understood that A may be directly connected to B or indirectly connected to B. In another example, in the description of “A is above B”, unless it is explicitly stated that A is directly above B (A and B are adjacent and A is above B), it should be understood that A may be directly above B or indirectly above B (A and B are separated by another element and A is above B). The rest may be inferred by analogy.

A device fixing bracket provided in this disclosure may be used for fixing a target device. The target device may be a navigation device and/or an image acquisition device. The navigation device may be an electronic device that can be used for navigation, such as a mobile phone or a tablet computer. The image acquisition device may be a device that can capture photos or videos, such as a mobile phone, a tablet computer, or a camera. The device fixing bracket can be mounted on a vehicle, and in particular, a short-distance vehicle, such as a kick scooter, a tricycle, a self-balancing scooter, a bicycle, or an electric vehicle. In the present disclosure, the term “vehicle” refers to any type of transportation designed primarily for short-distance travel, typically for daily commutes to and from work, school, or other regular destinations. vehicles in the present disclosure are intended to provide convenience, efficiency, and reliability for frequent use and can include a wide range of modes of transport such as, but not limited to, bicycles, electric bikes, scooters (e.g., kick scooters, mobility scooters, and electric scooters), self-balancing personal transporters (e.g., self-balancing scooters, hoverboards, self-balancing unicycles), motorcycles, compact cars, and personal mobility devices, etc. The device fixing bracket provided in this disclosure may also be used in other scenarios, such as a portable device fixing scenario (for example, a camera fixing bracket) to facilitate storage when carried in travel.

A conventional device fixing bracket is generally used in a vehicle as an auxiliary functional device. Therefore, a structural design of the conventional device fixing bracket may adopt a design style different from an overall design concept of the vehicle, making it difficult for the conventional device fixing bracket to be compatible with the vehicle in terms of structural design. There are many problems in functional coordination or structural coordination between the conventional device fixing bracket and the vehicle. For example, the conventional device fixing bracket used in the vehicle is generally directly mounted on a handlebar of the vehicle via a mechanical connection. After being mounted, the conventional device fixing bracket is generally exposed outside the handlebar. The exposed device fixing bracket is not attractive and easily blocks the field of vision of a rider, causing a safety accident. In addition, the conventional device fixing bracket generally clamps a target device by generating an engagement force or a clamping force. An operator needs to change a status of the conventional device fixing bracket to complete a clamping action. The operation is inconvenient.

The device fixing bracket provided in this disclosure has a structural shape different from the conventional device fixing bracket directly mounted on the vehicle. The device fixing bracket provided in this disclosure establishes a pair of active mechanisms capable of relative movement and a pair of passive mechanisms capable of relative movement driven by the active mechanisms. The active mechanisms include a first member and a second member. The passive mechanisms include a first clamping portion and a second clamping portion. The passive mechanisms also serve as clamping mechanisms for the target device, and then a pull-back structure capable of driving the first member and the second member to move toward each other in a free state is disposed, so that the device fixing bracket can autonomously clamp the target device and is convenient to use. In addition, the pull-back structure can make at least a part of the second member covered by the first member, thereby achieving an objective of reducing a volume of the device fixing bracket. On the other hand, when the device fixing bracket is used on the vehicle, the device fixing bracket can be at least partially or fully stored inside the vehicle, so that the vehicle can retain its original appearance as much as possible, thereby ensuring aesthetics and safety of the vehicle.

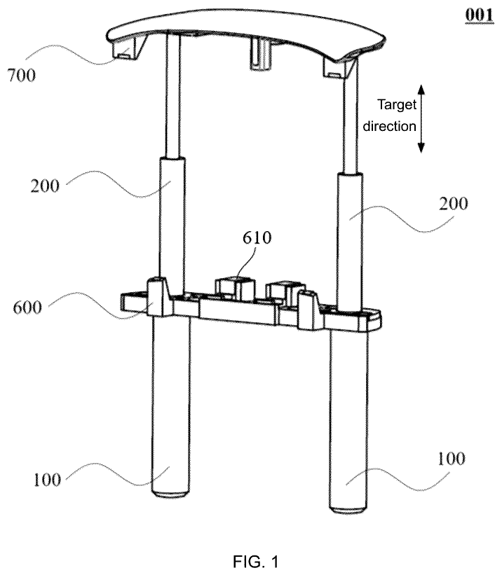

FIG. 1 is an oblique view of a device fixing bracket 001 in an open state according to some exemplary embodiments of this disclosure. In some exemplary embodiments provided in this disclosure, the device fixing bracket 001 includes a first member, a second member, a first clamping portion 600, a second clamping portion 700, and a pull-back structure.

The first member and the second member form the foregoing active mechanisms. The first member and the second member are constructed to be capable of moving toward or moving away from each other along a target direction. It should be noted herein that “moving toward” and “moving away” refer to a relative movement state of the first member and the second member, and do not mean that the two must move into a specific way, and therefore cannot be understood as a limitation on this disclosure. In other words, to implement relative movement, the first member and the second member may both move along the target direction, or only the first member or only the second member may move along the target direction. In the following description, “moving toward” and “moving away” also have the same meanings as above, and are not described again later. In addition, the target direction in some exemplary embodiments of this disclosure refers to a direction in which a target device can be clamped or released, that is, when the first member and the second member move relative to each other, the target device can be clamped or released.

Theoretically, the first member and the second member may take any structural form, as long as the two can move relative to each other. For example, a columnar shape, a linear guide rail, a sliding table, and the like are mainly listed in embodiments of this disclosure. In embodiments not listed in this disclosure, the first member and the second member may also be in other structural forms, such as a combination of a columnar shape and a hollow base. For example, the second member is in a columnar shape and the first member is a hollow base. In this case, the second member can move into the hollow base, thereby implementing relative movement of the first member and the second member. For example, a structural form is a combination of a columnar shape and a spherical base. For example, the second member is in a columnar shape and the first member is a spherical base. In this case, the second member can move on the spherical base, thereby implementing relative movement of the first member and the second member. On the other hand, the first member and the second member may also have a variety of positional relationships. For example, the first member and the second member are two separated members. For example, the second member may be at least partially stored in the first member.

The first clamping portion 600 and the second clamping portion 700 form the foregoing passive mechanisms. The first clamping portion 600 is connected to the first member, the second clamping portion 700 is connected to the second member, and the second clamping portion 700 and the first clamping portion 600 are disposed opposite to each other along the target direction. Therefore, when the first member and the second member move toward each other, the first clamping portion 600 and the second clamping portion 700 also move toward each other to clamp the target device, or when the first member and the second member move away from each other, the first clamping portion 600 and the second clamping portion 700 also move away from each other to achieve an objective of releasing the target device.

It should be noted herein that a main function of the first clamping portion 600 and the second clamping portion 700 is to clamp or release the target device by moving toward or moving away from each other. Therefore, the first clamping portion 600 and the second clamping portion 700 only need to be able to clamp the target device. It may be understood that there are many types of target devices with different shapes. To achieve an objective of clamping a variety of target devices with the same device fixing bracket 001, in some exemplary embodiments, the first clamping portion 600 and the second clamping portion 700 may be designed as a structure easily detachable from the first member or the second member. For different target devices, a device fixing bracket 001 may be provided with a variety of different first clamping portions 600 and second clamping portions 700. When the target device needs to be replaced, the requirement can be met by replacing different first clamping portions 600 and second clamping portions 700. In addition, in the design of some details of the first clamping portion 600 and the second clamping portion 700, for example, when it is necessary to select materials of the first clamping portion 600 and the second clamping portion 700, materials that do not easily damage the target device should be selected if possible, including but not limited to plastic, acrylic, ABS, and the like. For example, when it is necessary to design clamping portions of the first clamping portion 600 and the second clamping portion 700, clamping stability should be considered. For example, a protrusion 610 and the like are designed at edges of the first clamping portion 600 and the second clamping portion 700. An area enclosed by the first clamping portion 600 and the second clamping portion 700 is used to clamp the target device, and a contact area is large. The protrusion 610 and the like can prevent the target device from detaching from the first clamping portion 600 and the second clamping portion 700.

The pull-back structure is connected between the first member and the second member, so that the second clamping portion 700 and the first clamping portion 600 can move toward each other under a pull-back force of the pull-back structure. The pull-back structure causes the first clamping portion 600 and the second clamping portion 700 to have a trend to move toward each other, and this trend can facilitate clamping the target device after the target device is placed between the first clamping portion 600 and the second clamping portion 700. It should be noted herein that “the pull-back structure is connected between the first member and the second member” does not mean or imply that there is a physical connection relationship between the pull-back structure and the first member or between the pull-back structure and the second member, but only means that the pull-back structure can act on the first member and the second member and hence act on the first clamping portion 600 and the second clamping portion 700.

When the device fixing bracket 001 is in operation, the second clamping portion 600 and the first clamping portion 700 clamp the target device under the pull-back force, or when the device fixing bracket 001 is not in operation, at least a part of the second member is covered by the first member under the pull-back force.

It should be noted that “covering” herein may be understood as spatial overlapping, that is, when the second member is covered by the first member, the second member and the first member form an overlapping area. In this case, the second member may be partially or fully stored in/under the first member. Alternatively, the second member may be located outside the first member, but the two have a spatial overlapping relationship.

In some exemplary embodiments of this disclosure, the device fixing bracket 001 includes the first member and the second member, and the first member and the second member can move toward or move away from each other along the target direction. In addition, the first clamping portion 600 is connected to the first member and the second clamping portion 700 is connected to the second member, so that when the first member and the second member move relative to each other, the first clamping portion 600 and the second clamping portion 700 also move toward or move away from each other, thereby achieving an objective of clamping the target device. In this case, in combination with the pull-back structure, the pull-back force provided by the pull-back structure can achieve an objective of stably clamping the target device, so that the first clamping portion 600 and the second clamping portion 700 can autonomously clamp the target device to facilitate use. In addition, based on the pull-back force, when the device fixing bracket 001 does not need to clamp the target device, at least a part of the second member may be covered by the first member, and the second member and the first member can share at least a part of space, so that a total volume of space occupied by the two members can be reduced, thereby reducing a volume of the device fixing bracket 001, and improving safety while improving aesthetics.

In some exemplary embodiments, as shown in FIG. 1, the first member includes a bracket base 100, the second member includes a sliding rod assembly 200, and the pull-back structure includes an elastic apparatus (not shown in FIG. 1). In this case, the device fixing bracket 001 may include the bracket base 100, the sliding rod assembly 200, the elastic apparatus, the first clamping portion 600, and the second clamping portion 700.

The bracket base 100 may include a first accommodating cavity (not shown in FIG. 1) extending along the target direction (direction indicated by an arrow). The bracket base 100 may be a base of the device fixing bracket. The bracket base 100 may be in any shape. For example, the shape of the bracket base 100 may be a column extending along the target direction, or a shape that is convenient for gripping or mounting. There may be one first accommodating cavity, or a plurality of first accommodating cavities may be disposed in parallel. Correspondingly, the bracket base 100 may include one column, or may include a plurality of columns disposed in parallel, and the plurality of columns may be fixedly connected together. For example, two columns are shown in FIG. 1.

One end of the sliding rod assembly 200 may pass through the first accommodating cavity and is slidably connected to the first accommodating cavity along the target direction. The sliding rod assembly 200 may move toward the bracket base 100 or move away from the bracket base 100 in the target direction relative to the bracket base 100. For example, when the sliding rod assembly 200 moves toward a first direction, the sliding rod assembly 100 moves toward a direction away from the first accommodating cavity, thereby extending out of the first accommodating cavity. When the sliding rod assembly 200 moves toward a second direction, the sliding rod assembly 100 moves in a direction toward the first accommodating cavity, thereby retracting into the first accommodating cavity. The first direction and the second direction are two opposite directions along the target direction.

In the foregoing exemplary embodiments, the first member and the second member in cooperation are configured as the bracket base 100 and the sliding rod assembly 200, and the relative movement of the first member and the second member may be implemented by sliding the sliding rod assembly 200 in the first accommodating cavity. The first accommodating cavity can provide directional guidance for the movement of the sliding rod assembly 200. Therefore, the path is standardized and the relative movement can be performed smoothly.

The first clamping portion 600 may be connected to the bracket base 100. The first clamping portion 600 may be fixedly connected to the bracket base 100. The fixed connection may be established in many different manners, such as integral molding, threaded connection, welding, bonding, riveting, and snap-fitting. The second clamping portion 700 may be connected to the sliding rod assembly 200. The second clamping portion 700 may be fixedly connected to the sliding rod assembly 200. The fixed connection may be established in many different manners, such as integral molding, threaded connection, welding, bonding, riveting, and snap-fitting.

The first clamping portion 600 and the second clamping portion 700 may be disposed opposite to each other along the target direction. The first clamping portion 600 and the second clamping portion 700 may be configured to clamp the target device.

The elastic apparatus may be located in the first accommodating cavity. Two ends of the elastic apparatus may respectively abut against the sliding rod assembly 200 and the first accommodating cavity, thereby providing an elastic force between the sliding rod assembly 200 and the first accommodating cavity. Specifically, the elastic apparatus may provide the elastic force to enable the sliding rod assembly 100 and the first accommodating cavity to move toward each other. To be specific, in absence of an external force, the elastic force provided by the elastic apparatus may enable the sliding rod assembly 100 to move in a direction toward the first accommodating cavity, thereby retracting into the first accommodating cavity and achieving an objective of automatic retracting. The second clamping portion 600 and the first clamping portion 700 may move in a direction toward each other under the elastic force of the elastic apparatus.

When the device fixing bracket 001 is in operation, the second clamping portion 700 and the first clamping portion 600 clamp the target device under the elastic force of the elastic apparatus. When the device fixing bracket 001 is not in operation, the sliding rod assembly 200 moves in a direction toward the bracket base 100 under the elastic force of the elastic apparatus, so that the sliding rod assembly 200 is stored in the first accommodating cavity to retract the device fixing bracket 001. For example, the target device may be disposed between the first clamping portion 600 and the second clamping portion 700, and the first clamping portion 600 and the second clamping portion 700 may clamp the target device under the elastic force of the elastic apparatus. The first clamping portion 600 and the second clamping portion 700 may each clamp an edge of the target device, such as a long side or a short side of a mobile phone. Because the sliding rod assembly 200 may be slidably connected to the bracket base 100, a distance between the first clamping portion 600 and the second clamping portion 700 may be adjustable to adapt to target devices of different sizes, so that the target devices of different sizes can be reliably clamped. In some exemplary embodiments, to further improve clamping reliability, extensions of the first clamping portion 600 and the second clamping portion 700 may be further provided with protrusions to prevent the target device from falling. To reduce the volume of the device fixing bracket after retraction, the protrusion of the first clamping portion 600 and the protrusion of the second clamping portion 700 may be staggered.

In some exemplary embodiments, the first clamping portion 600 may be located at any position of the bracket base 100. For example, the first clamping portion 600 is located at either end of the bracket base 100 in the target direction, or passes through the end of the bracket base 100 and is located at any position between the two ends of the bracket base 100. In some exemplary embodiments, the second clamping portion 700 may be located at any position of the sliding rod assembly 200. For example, the second clamping portion 700 is located at either end of the sliding rod assembly 200 in the target direction, or passes through the end of the sliding rod assembly 200 and is located at any position between the two ends of the sliding rod assembly 200. To make the volume of the device fixing bracket 001 smaller when the device fixing bracket 001 is retracted, the first clamping portion 600 may be located at one end of the bracket base 100 close to the second clamping portion 700, and the second clamping portion 700 is located at one end of the sliding rod assembly 200 away from the slidable connection with the first accommodating cavity. When the device fixing bracket 001 is not in operation, the second clamping portion 700 abuts against the first clamping portion 600, thereby reducing the volume of the device fixing bracket 001.

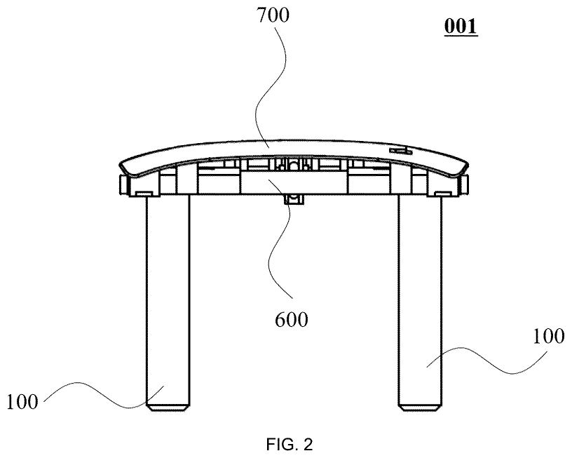

FIG. 2 is a front view of a device fixing bracket 001 in a retracted state according to some exemplary embodiments of this disclosure. As shown in FIG. 2, when not in operation, the device fixing bracket 001 can automatically retract under the elastic force of the elastic apparatus to facilitate use. In the retracted device fixing bracket 001, the sliding rod assembly 200 retracts into the first accommodating cavity of the bracket base 100, and the first clamping portion 600 abuts against the second clamping portion 700, thereby greatly reducing the volume after retraction, so that the device fixing bracket is not only more attractive but also safer.

As mentioned above, the sliding rod assembly 200 may be slidably connected to the bracket base 100. The sliding rod assembly 100 may be a one-stage sliding rod. To further reduce the volume of the retracted device fixing bracket 001, the sliding rod assembly 200 may alternatively be a two-stage sliding rod, or even a three-stage sliding rod, a four-stage sliding rod, or the like.

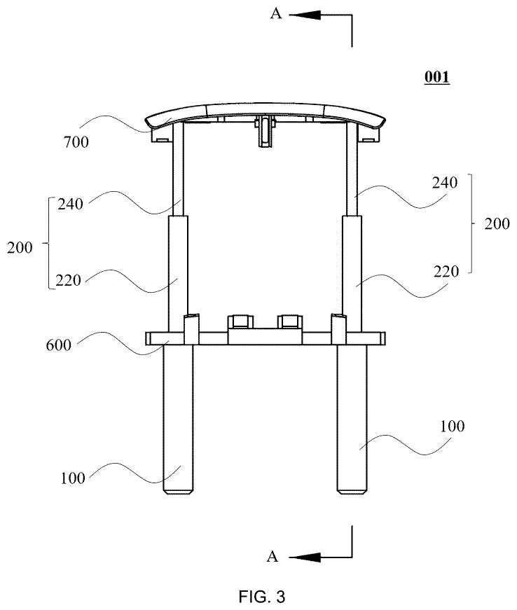

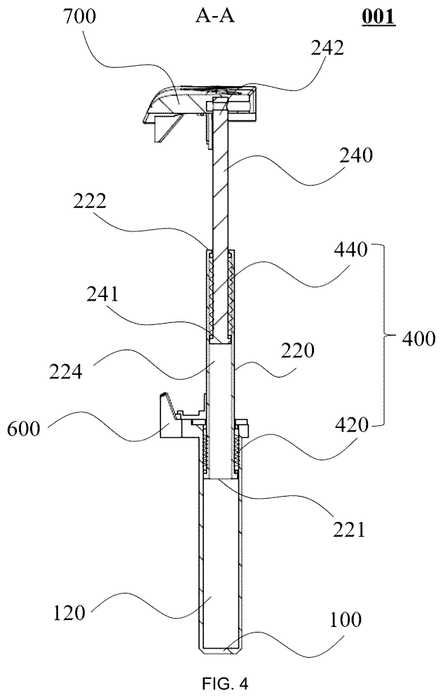

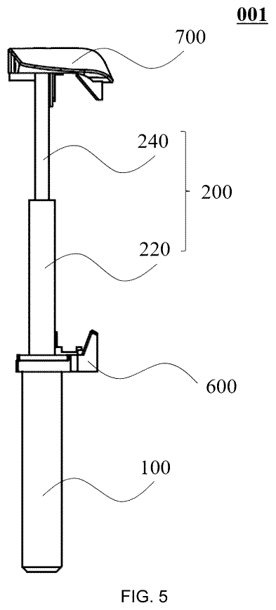

FIG. 3 is a front view of a device fixing bracket 001 in an open state according to some exemplary embodiments of this disclosure. FIG. 4 is a sectional view A-A according to FIG. 3. FIG. 5 is a left view of a device fixing bracket 001 in an open state according to some exemplary embodiments of this disclosure. The sliding rod assembly 200 shown in FIG. 3 to FIG. 5 is a two-stage sliding rod. As shown in FIG. 3 to FIG. 5, the two-stage sliding rod may include a first sliding rod 220 and a second sliding rod 240.

The first sliding rod 220 may extend along the target direction. One end of the first sliding rod 220 may pass through the first accommodating cavity 120 and is slidably connected to the first accommodating cavity 120 along the target direction. For ease of description, one end of the first sliding rod 220 that is slidably connected to the first accommodating cavity 120 is defined as a first end 221 of the first sliding rod 220, and the other end of the first sliding rod 220 is defined as a second end 222 of the first sliding rod 220. The first end 221 of the first sliding rod 220 and the second end 222 of the first sliding rod 220 are disposed opposite to each other along the target direction. The first end 221 of the first sliding rod 220 may pass through one end of the first accommodating cavity 120 close to the second clamping portion 700, or one end at which the first clamping portion 600 is located.

For ease of description, one end of the first accommodating cavity 120 close to the second clamping portion 700 or one end at which the first clamping portion 600 is located is defined as a first end of the first accommodating cavity 120, and the other end of the first accommodating cavity 120 is defined as a second end of the first accommodating cavity 120. The first end of the first accommodating cavity 120 may be an open end. The second end of the first accommodating cavity 120 may be an open end or a closed end. In other words, the first accommodating cavity 120 may be an open cavity that runs through the bracket base 100, or a half-closed cavity with one end open and the other end closed.

A cross-sectional shape and size of the first accommodating cavity 120 match a cross-sectional shape and size of one end of the first sliding rod 220 that is slidably connected to the first accommodating cavity 120. The matching herein may be that the cross-sectional shapes are consistent and that the cross-sectional sizes are within an error range allowed for normal operation. The first sliding rod 220 may slide along the target direction relative to the first accommodating cavity 120. When the first sliding rod 220 moves in the first direction relative to the first accommodating cavity 120, the first sliding rod 220 moves in the direction away from the bracket base 100, so that the distance between the first clamping portion 600 and the second clamping portion 700 increases. When the first sliding rod 220 moves in the second direction relative to the first accommodating cavity 120, the first sliding rod 220 moves in the direction toward the bracket base 100, so that the distance between the first clamping portion 600 and the second clamping portion 700 decreases.

The first sliding rod 220 may include a second accommodating cavity 224 extending along the target direction. For ease of description, one end of the second accommodating cavity 224 close to the second clamping portion 700 is defined as a first end of the second accommodating cavity 224, and the other end of the second accommodating cavity 224 is defined as a second end of the second accommodating cavity 224. The first end of the second accommodating cavity 224 may be an open end. The second end of the second accommodating cavity 224 may be an open end or a closed end. In other words, the second accommodating cavity 224 may be an open cavity that runs through the first sliding rod 220, or a half-closed cavity with one end open and the other end closed.

One end of the second sliding rod 240 may pass through the second accommodating cavity 224 and is slidably connected to the second accommodating cavity 224 along the target direction. For ease of description, one end of the second sliding rod 240 that is slidably connected to the second accommodating cavity 224 is defined as a first end 241 of the second sliding rod 240, and the other end of the second sliding rod 240 is defined as a second end 242 of the second sliding rod 240. The first end 241 of the second sliding rod 240 and the second end 242 of the second sliding rod 240 are disposed opposite to each other along the target direction. The first end 241 of the second sliding rod 240 may pass through the first end of the second accommodating cavity 224. The second clamping portion 700 may be connected to the second sliding rod 240. The second clamping portion 700 may be disposed at the second end 242 of the second sliding rod 240.

A cross-sectional shape and size of the second accommodating cavity 224 match a cross-sectional shape and size of one end of the second sliding rod 240 that is slidably connected to the second accommodating cavity 224. The matching herein may be that the cross-sectional shapes are consistent and that the cross-sectional sizes are within an error range allowed for normal operation. The second sliding rod 240 may slide along the target direction relative to the second accommodating cavity 224. When the second sliding rod 240 moves toward the first direction relative to the second accommodating cavity 224, the second sliding rod 240 moves toward the direction away from the bracket base 100, so that the distance between the first clamping portion 600 and the second clamping portion 700 increases. When the second sliding rod 240 moves in the second direction relative to the second accommodating cavity 224, the second sliding rod 240 moves in the direction toward the bracket base 100, so that the distance between the first clamping portion 600 and the second clamping portion 700 decreases.

The elastic apparatus 400 may include a two-stage elastic apparatus. The two-stage elastic apparatus may include a first elastic apparatus 420 and a second elastic apparatus 440. The first elastic apparatus 420 may be located in the first accommodating cavity 120. One end of the first elastic apparatus 420 may abut against the first accommodating cavity 120, and the other end of the first elastic apparatus 420 may abut against one end of the first sliding rod 220 slidably connected to the first accommodating cavity 120. The second elastic apparatus 440 may be located in the second accommodating cavity 224. One end of the second elastic apparatus 440 may abut against the second accommodating cavity 222, and the other end of the second elastic apparatus 440 may abut against one end of the second sliding rod 240 slidably connected to the second accommodating cavity 224. Rigidity of the first elastic apparatus 420 and the second elastic apparatus 440 may be the same or different.

The first elastic apparatus 420 and the second elastic apparatus 440 may be compression springs. The elastic force may be implemented by making the spring in a compressed state, or may be implemented by making the spring in a stretched state. The first elastic apparatus 420 and the second elastic apparatus 440 in the device fixing bracket 001 shown in FIG. 3 to FIG. 5 are in the compressed state. As shown in FIG. 3 to FIG. 5, one end of the first elastic apparatus 420 abuts against one end of the first accommodating cavity 120 close to the second clamping portion 700, the other end of the first elastic apparatus 420 abuts against one end of the first sliding rod 220 slidably connected to the first accommodating cavity 120, that is, one end of the first elastic apparatus 420 may abut against the first end of the first accommodating cavity 120, and the other end of the first elastic apparatus 420 may abut against the first end 221 of the first sliding rod 220. In this case, the first elastic apparatus 420 is in the compressed state. A first boss extending toward the center may be disposed at the first end of the first accommodating cavity 120. A second boss extending away from the center may be disposed at the first end 221 of the first sliding rod 220. The two ends of the first elastic apparatus 420 may press against the first boss and the second boss respectively. A side surface of the second boss may be slidably connected to the first accommodating cavity 120. The slidable connection between the side surface of the second boss and the first accommodating cavity 120 may be implemented by a linear bearing. The linear bearing may be a rolling bearing or a sliding bearing. The second boss may be an end surface of the linear bearing.

In the foregoing description, the first elastic apparatus 420 is in the compressed state after being assembled in place. In this case, the first elastic apparatus 420 accumulates an elastic restoring force. The elastic restoring force, combined with a connection position of the first elastic apparatus 420 (that is, one end of the first elastic apparatus 420 abuts against the first end of the first accommodating cavity 120, and the other end of the first elastic apparatus 420 abuts against the first end 221 of the first sliding rod 220), may cause the first sliding rod 220 to have a trend to move into the first accommodating cavity 120 along the second direction. This trend enables the first clamping portion 600 and the second clamping portion 700 to tighten the target device when working, and the first sliding rod 220 may retract into the first accommodating cavity 120 when not in operation.

In some exemplary embodiments, the elastic force may alternatively be implemented by making the spring in the stretched state. When the second end of the first accommodating cavity 120 is a closed end, one end of the first elastic apparatus 420 may abut against the second end of the first accommodating cavity 120, and the other end of the first elastic apparatus 420 may abut against the first end 221 of the first sliding rod 220. In this case, the first elastic apparatus 420 is in the stretched state.

In the foregoing description, the first elastic apparatus 420 is in the stretched state after being assembled in place. In this case, the first elastic apparatus 420 accumulates an elastic restoring force. The elastic restoring force, combined with the connection position of the first elastic apparatus 420 (that is, one end of the first elastic apparatus 420 abuts against the second end of the first accommodating cavity 120, and the other end of the first elastic apparatus 420 abuts against the first end 221 of the first sliding rod 220), may cause the first sliding rod 220 to have a trend to move into the first accommodating cavity 120 along the second direction. This trend enables the first clamping portion 600 and the second clamping portion 700 to tighten the target device when working, and the first sliding rod 220 may retract into the first accommodating cavity 120 when not in operation.

As shown in FIG. 3 to FIG. 5, one end of the second elastic apparatus 440 may abut against the first end of the second accommodating cavity 224, and the other end of the second elastic apparatus 440 may abut against the first end 241 of the second sliding rod 240. In this case, the second elastic apparatus 440 is in the compressed state. A third boss extending toward the center may be disposed at the first end of the second accommodating cavity 224. A fourth boss extending away from the center may be disposed at the first end 241 of the second sliding rod 240. The two ends of the second elastic apparatus 440 may press against the third boss and the fourth boss respectively. A side surface of the fourth boss may be slidably connected to the second accommodating cavity 224. The slidable connection between the side surface of the fourth boss and the second accommodating cavity 224 may be implemented by a linear bearing. The linear bearing may be a rolling bearing or a sliding bearing. The fourth boss may be an end surface of the linear bearing.

In the foregoing description, the second elastic apparatus 440 is in the compressed state after being assembled in place. In this case, the second elastic apparatus 440 accumulates an elastic restoring force. The elastic restoring force, combined with a connection position of the second elastic apparatus 440 (that is, one end of the second elastic apparatus 440 may abut against the first end of the second accommodating cavity 224, and the other end of the second elastic apparatus 440 may abut against the first end 241 of the second sliding rod 240), may cause the second sliding rod 240 to have a trend to move into the second accommodating cavity 224 along the second direction. This trend enables the first clamping portion 600 and the second clamping portion 700 to tighten the target device when working, and the second sliding rod 240 may retract into the second accommodating cavity 224 when not in operation.

In some exemplary embodiments, the elastic force may alternatively be implemented by making the spring in the stretched state. When the second end of the second accommodating cavity 224 is a closed end, one end of the second elastic apparatus 440 may abut against the second end of the second accommodating cavity 224, and the other end of the second elastic apparatus 440 may abut against the first end 421 of the second sliding rod 240. In this case, the second elastic apparatus 440 is in the stretched state.

In the foregoing description, the second elastic apparatus 440 is in the stretched state after being assembled in place. In this case, the second elastic apparatus 440 accumulates an elastic restoring force. The elastic restoring force, combined with the connection position of the second elastic apparatus 440 (that is, one end of the second elastic apparatus 440 may abut against the second end of the second accommodating cavity 224, and the other end of the second elastic apparatus 440 may abut against the first end 421 of the second sliding rod 440), may cause the second sliding rod 240 to have a trend to move into the second accommodating cavity 224 along the second direction. This trend enables the first clamping portion 600 and the second clamping portion 700 to tighten the target device when working, and the second sliding rod 220 may retract into the second accommodating cavity 224 when not in operation.

In some exemplary embodiments, the sliding rod assembly 200 may be a one-stage sliding rod. When the sliding rod assembly 200 is a one-stage sliding rod, a first end of the one-stage sliding rod may be slidably connected to the first accommodating cavity 120, and the second clamping portion 700 may be disposed at a second end of the one-stage sliding rod. In this case, the elastic apparatus 400 may include a one-stage elastic apparatus. An elastic force of the one-stage elastic apparatus may be implemented by making the spring in the compressed state or making the spring in the stretched state. When the one-stage elastic apparatus is in the compressed state, one end of the one-stage elastic apparatus abuts against one end of the first accommodating cavity 120 close to the second clamping portion 700, and the other end of the one-stage elastic apparatus abuts against one end of the one-stage sliding rod slidably connected to the first accommodating cavity 120. A first boss extending toward the center is disposed at the first end of the first accommodating cavity 120, a second boss extending away from the center is disposed at the first end of the one-stage sliding rod, the one-stage elastic apparatus presses against the first boss and the second boss respectively, and a side surface of the second boss is slidably connected to the first accommodating cavity 120. When the one-stage elastic apparatus is in the stretched state, one end of the one-stage elastic apparatus abuts against one end of the first accommodating cavity 120 away from the second clamping portion 700, and the other end of the one-stage elastic apparatus abuts against one end of the one-stage sliding rod slidably connected to the first accommodating cavity 120.

In the foregoing description, the one-stage sliding rod may be understood based on the foregoing first sliding rod 220, and the one-stage elastic apparatus may be understood based on the foregoing first elastic apparatus 420. Their principles and functions have been described in detail above and are not described herein again.

In the related description above, the core of the one-stage elastic apparatus and the two-stage elastic apparatus is to provide the elastic restoring force, and material selection of the one-stage elastic apparatus and the two-stage elastic apparatus is not limited. For example, the one-stage elastic apparatus and the two-stage elastic apparatus may use the foregoing compression spring. In another example, the one-stage elastic apparatus and the two-stage elastic apparatus may alternatively use other parts or components made of materials with elastic properties. These materials with elastic properties may be rubber, elastic silicone, and the like.

In some exemplary embodiments, the pull-back structure may alternatively be a magnetic apparatus, which generates a magnetic force to implement relative movement of the first member and the second member. A part of the magnetic apparatus is disposed on the first member, for example, an N pole of the magnetic apparatus is disposed on the first member. Another part of the magnetic apparatus is disposed on the second member, for example, an S pole of the magnetic apparatus is disposed on the second member. In this case, a function of the pull-back structure is performed by magnetic attraction. Specifically, in the foregoing description, the N pole may be disposed on the bracket base 100, the S pole may be disposed on the sliding rod assembly 200, and a magnetic adsorption force may drive the sliding rod assembly 200 to move into the first accommodating cavity 120. Certainly, a part of the magnetic apparatus may alternatively be disposed on the first clamping portion 600, and another part of the magnetic apparatus may be disposed on the second clamping portion 700, with the same effect produced. In addition, the magnetic apparatus may be disposed on all of the first member, the second member, the first clamping portion 600, and the second clamping portion 700.

In some exemplary embodiments, the first member may alternatively be a linear guide rail, and the second member may alternatively be a sliding table. A protruding locking strip may be disposed on the linear guide rail, and the protruding locking strip may extend along the target direction. The sliding table may include a slot that fits the protruding locking strip, so that the sliding table is slidably connected to the linear guide rail along the target direction. In some exemplary embodiments, to implement relative sliding between the linear guide rail and the sliding table, a driving mechanism may be disposed on the linear guide rail, and the driving mechanism serves as the pull-back structure in these exemplary embodiments. The driving mechanism may be connected to the sliding table, so that the sliding table can move along the protruding locking strip. The driving mechanism may be a screw driving mechanism, a belt driving mechanism, or a driving motor, which is not limited in this disclosure. For example, when the driving mechanism uses a screw driving mechanism, a screw may be arranged on one side of the protruding locking strip along an extension direction of the protruding locking strip, while maintaining a parallel relationship with the protruding locking strip. A slider connected to the sliding table may be provided on the screw, and when the screw moves, the slider may drive the sliding table to move. For example, when the driving mechanism adopts a belt driving mechanism, a conveyor belt may also be arranged on one side of the protruding locking strip, and the sliding table may be connected to the conveyor belt. For example, when the driving mechanism uses a driving motor, an output shaft of the driving motor can act on the sliding table.

This disclosure may provide a vehicle. The vehicle may be a kick scooter, a tricycle, a self-balancing scooter, a bicycle, an electric vehicle, or the like. The vehicle may include a vehicle body and the device fixing bracket provided in this disclosure.

The vehicle body may be a base and a main structure of the vehicle. The vehicle body may be configured to connect various components of the vehicle and may be further configured to carry a user. The vehicle body may include a handlebar. The handlebar may be used by the user to operate the vehicle, such as operating the vehicle to move forward and turn. The device fixing bracket may be mounted on the handlebar. Specifically, the device fixing bracket may be mounted in a housing on the handlebar.

The vehicle may further include other components, such as the device fixing bracket, a drive system, and a steering system, which are not limited in this disclosure.

To clearly describe the structure and function of the vehicle, a vehicle including a device fixing bracket 001 is used as an example for further description hereinafter, and the device fixing bracket 001 in the vehicle may be one of the foregoing exemplary embodiments.

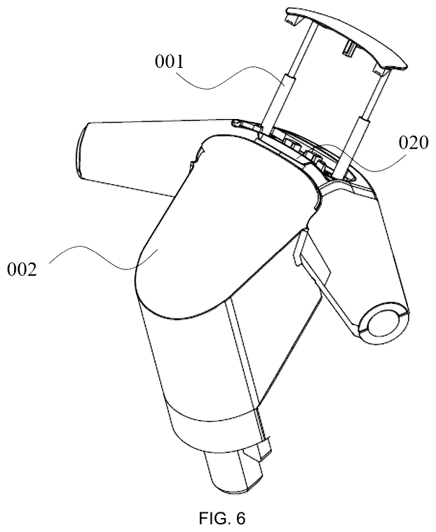

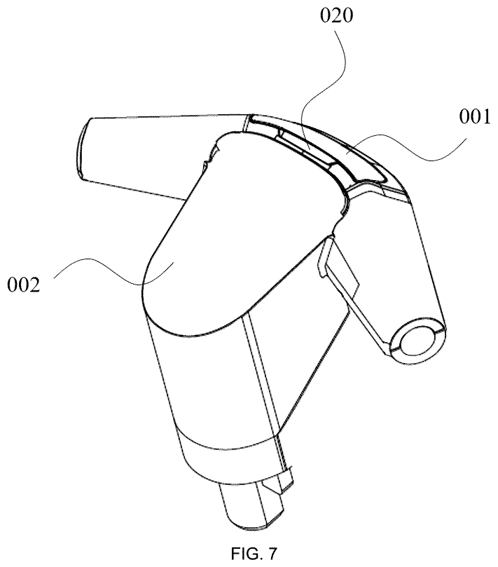

FIG. 6 is a schematic structural diagram of a device fixing bracket 001 on a handlebar 002 in an open state according to some exemplary embodiments of this disclosure. FIG. 7 is a schematic structural diagram of a device fixing bracket 001 on a handlebar 002 in a retracted state according to some exemplary embodiments of this disclosure. As shown in FIG. 6 and FIG. 7, the device fixing bracket 001 may be mounted on a handlebar of a vehicle. A bracket base 100 may be mounted in a housing on the handlebar 002. When the device fixing bracket 001 is in operation, a first clamping portion 600 and a second clamping portion 700 are exposed outside the housing on the handlebar 002. When the device fixing bracket 001 is not in operation, the device fixing bracket 001 is hidden in the housing on the handlebar 002. An outer surface of the second clamping portion 700 forms a part of the housing on the handlebar 002. A design of the outer surface of the second clamping portion 700 may be consistent with a housing design of the handlebar 002, so that when the device fixing bracket 001 is hidden in the housing on the handlebar 002, it can be more attractive. A notch 020 is provided at a joint between the housing on the handlebar 002 and the device fixing bracket 001, so that the second clamping portion 700 is stretched toward a target direction through the notch 020.

It should be noted that, for details of the device fixing bracket 001 not disclosed in the apparatus embodiments of this disclosure, reference may be made to the drawings of the disclosure provided in this disclosure. Details are not described herein again.

In the foregoing device fixing bracket 001 and vehicle, a first accommodating cavity 120 is provided on the bracket base 100, and a sliding rod assembly 200 is slidably connected to the first accommodating cavity 120. An elastic apparatus 400 is disposed between the sliding rod assembly 200 and the bracket base 100, so that the sliding rod assembly 200 and the bracket base 100 can move toward each other under an elastic force of the elastic apparatus. Therefore, when the device fixing bracket 001 is in use, the first clamping portion 600 and the second clamping portion 700 can clamp a target device under the action of the elastic apparatus. When the device fixing bracket 001 is not in use, the sliding rod assembly 200 is accommodated in the first accommodating cavity 120, thereby reducing a volume of the device fixing bracket 001. The device fixing bracket 001 provided in this disclosure can automatically retract under the elastic force of the elastic apparatus, and is easy to use. The sliding rod assembly 200 of the retracted device fixing bracket 001 retracts into the first accommodating cavity 120 of the bracket base 100, so that the retracted device fixing bracket 001 is smaller, more attractive, and safer. In the vehicle provided in this disclosure, the device fixing bracket 001 is mounted in the housing on the handlebar 002 of the vehicle. Therefore, the retracted device fixing bracket 001 can be hidden in the housing on the handlebar 002, further improving aesthetics and safety of the vehicle.

Specific exemplary embodiments of this disclosure have been described above. Other embodiments also fall within the scope of the appended claims. In some cases, the actions or steps described in the claims may be implemented in an order different from the order in exemplary embodiments and the expected results can still be achieved. In addition, the processes depicted in the drawings do not necessarily require a specific order or sequence to achieve the expected results. In some exemplary embodiments, multitask processing and parallel processing are also possible or may be advantageous.

In summary, after reading this detailed disclosure, a person skilled in the art may understand that the foregoing detailed disclosure may be presented by using examples only, and may not be restrictive. A person skilled in the art may understand that this disclosure needs to cover various reasonable changes, improvements, and modifications to the embodiments, although this is not specified herein. These changes, improvements, and modifications are intended to be proposed in this disclosure and are within the spirit and scope of the exemplary embodiments of this disclosure.

In addition, some terms in this disclosure are used to describe the embodiments of this disclosure. For example, “one embodiment”, “an embodiment”, and/or “some embodiments” mean/means that a specific feature, structure, or characteristic described with reference to the embodiment(s) may be included in at least one embodiment of this disclosure. Therefore, it may be emphasized and should be understood that in various parts of this disclosure, two or more references to “an embodiment” or “one embodiment” or “an alternative embodiment” do not necessarily all refer to the same embodiment. In addition, specific features, structures, or characteristics may be appropriately combined in one or more embodiments of this disclosure.

It should be understood that in the foregoing description of the embodiments of this disclosure, to help understand one feature, for the purpose of simplifying this disclosure, various features in this disclosure are combined in a single embodiment, single drawing, or description thereof. However, this does not mean that the combination of these features is necessary. It is possible for a person skilled in the art to mark out some of the devices as a separate embodiment for understanding after reading this disclosure. In other words, an embodiment in this disclosure may also be understood as an integration of a plurality of sub-embodiments. It is also true when content of each sub-embodiment may not include all features of a single embodiment as disclosed above.

Each patent, patent application, patent application publication, and other materials cited herein, such as articles, books, disclosures, publications, documents, and materials, except any historical prosecution document associated therewith, any identical historical prosecution document that may be inconsistent or conflicting with this document, or any identical historical prosecution document that may have a restrictive effect on the broadest scope of the claims, can be incorporated herein by reference and used for all purposes associated with this document at present or in the future. In addition, if there is any inconsistency or conflict in descriptions, definitions, and/or use of a term associated with this document and descriptions, definitions, and/or use of the term associated with any material, the term in this document shall prevail.

Finally, it should be understood that the implementation solutions of this disclosure disclosed herein illustrate the principles of the implementation solutions of this disclosure. Other modified embodiments shall also fall within the scope of this disclosure. Therefore, the embodiments disclosed in this disclosure are merely exemplary and not restrictive. A person skilled in the art may use alternative configurations to implement the technical effects in this disclosure according to the embodiments of this disclosure. Therefore, the embodiments of this disclosure are not limited to those embodiments precisely described in this disclosure.

What is claimed is:

1. A device fixing bracket for fixing a target device, comprising:
a first member;
a second member, wherein the first member and the second member are configured to move toward or move away from each other along a target direction;
a first clamping portion, connected to the first member;
a second clamping portion, connected to the second member and disposed opposite to the first clamping portion along the target direction; and
a pull-back structure, connected between the first member and the second member to enable the second clamping portion and the first clamping portion to move toward each other under a pull-back force of the pull-back structure, wherein
when the device fixing bracket is in operation, the second clamping portion and the first clamping portion clamp the target device under the pull-back force, or when the device fixing bracket is not in operation, at least a part of the second member is covered by the first member under the pull-back force.

2. The device fixing bracket according to claim 1, wherein the first member includes a bracket base, and the second member includes a sliding rod assembly, wherein
the bracket base includes a first accommodating cavity extending along the target direction, and
the sliding rod assembly is slidably connected to the first accommodating cavity along the target direction.

3. The device fixing bracket according to claim 1, wherein the target device includes at least one of a navigation device, or an image acquisition device.

4. The device fixing bracket according to claim 2, wherein the device fixing bracket is mounted on a handlebar of a vehicle, and the bracket base is mounted in a housing on the handlebar.

5. The device fixing bracket according to claim 2, wherein the first clamping portion is located at an end of the bracket base close to the second clamping portion, the second clamping portion is located at an end of the sliding rod assembly away from a slidable connection with the first accommodating cavity, and when the device fixing bracket is not in operation, the second clamping portion abuts against the first clamping portion.

6. The device fixing bracket according to claim 2, wherein the pull-back structure includes an elastic apparatus.

7. The device fixing bracket according to claim 6, wherein the sliding rod assembly includes a one-stage sliding rod, and the elastic apparatus includes a one-stage elastic apparatus.

8. The device fixing bracket according to claim 7, wherein an end of the one-stage elastic apparatus abuts against an end of the first accommodating cavity close to the second clamping portion, another end of the one-stage elastic apparatus abuts against an end of the one-stage sliding rod slidably connected to the first accommodating cavity, and the one-stage elastic apparatus is in a compressed state, wherein
a first boss extending toward a center is disposed at the end of the first accommodating cavity close to the second clamping portion, a second boss extending away from the center is disposed at an end of the one-stage sliding rod slidably connected to the first accommodating cavity, the one-stage elastic apparatus presses against the first boss and the second boss respectively, and a side surface of the second boss is slidably connected to the first accommodating cavity.

9. The device fixing bracket according to claim 7, wherein an end of the first accommodating cavity away from the second clamping portion is a closed end, an end of the one-stage elastic apparatus abuts against an end of the first accommodating cavity away from the second clamping portion, another end of the one-stage elastic apparatus abuts against an end of the one-stage sliding rod slidably connected to the first accommodating cavity, and the one-stage elastic apparatus is in a stretched state.

10. The device fixing bracket according to claim 6, wherein the sliding rod assembly includes a two-stage sliding rod, and the two-stage sliding rod includes:
a first sliding rod, including a second accommodating cavity extending along the target direction, wherein an end of the first sliding rod passes through the first accommodating cavity and is slidably connected to the first accommodating cavity along the target direction; and
a second sliding rod, wherein an end of the second sliding rod passes through the second accommodating cavity and is slidably connected to the second accommodating cavity along the target direction, wherein
the second clamping portion is connected to the second sliding rod.

11. The device fixing bracket according to claim 10, wherein the elastic apparatus includes a two-stage elastic apparatus, and the two-stage elastic apparatus includes:
a first elastic apparatus, located in the first accommodating cavity, wherein an end of the first elastic apparatus abuts against the first accommodating cavity, and another end of the first elastic apparatus abuts against an end of the first sliding rod slidably connected to the first accommodating cavity; and
a second elastic apparatus, located in the second accommodating cavity, an end of the second elastic apparatus abuts against the second accommodating cavity, and another end of the second elastic apparatus abuts against an end of the second sliding rod slidably connected to the second accommodating cavity.

12. The device fixing bracket according to claim 11, wherein an end of the first elastic apparatus abuts against an end of the first accommodating cavity close to the second clamping portion, another end of the first elastic apparatus abuts against an end of the first sliding rod slidably connected to the first accommodating cavity, and the first elastic apparatus is in a compressed state, wherein
a first boss extending toward a center is disposed at an end of the first accommodating cavity close to the second clamping portion, a second boss extending away from the center is disposed at an end of the first sliding rod slidably connected to the first accommodating cavity, the first elastic apparatus presses against the first boss and the second boss respectively, and a side surface of the second boss is slidably connected to the first accommodating cavity.

13. The device fixing bracket according to claim 11, wherein an end of the first accommodating cavity away from the second clamping portion is a closed end, two ends of the first elastic apparatus respectively abut against an end of the first accommodating cavity away from the second clamping portion and an end of the first sliding rod slidably connected to the first accommodating cavity, and the first elastic apparatus is in a stretched state.

14. The device fixing bracket according to claim 11, wherein an end of the second elastic apparatus abuts against an end of the second accommodating cavity close to the second clamping portion, another end of the second elastic apparatus abuts against an end of the second sliding rod slidably connected to the second accommodating cavity, and the second elastic apparatus is in a compressed state, wherein
a third boss extending toward a center is disposed at the end of the second accommodating cavity close to the second clamping portion, a fourth boss extending away from the center is disposed at the end of the second sliding rod slidably connected to the second accommodating cavity, the second elastic apparatus presses against the third boss and the fourth boss respectively, and a side surface of the fourth boss is slidably connected to the second accommodating cavity.

15. The device fixing bracket according to claim 11, wherein an end of the second accommodating cavity away from the second clamping portion is a closed end, two ends of the second elastic apparatus respectively abut against an end of the second accommodating cavity close to the second clamping portion and the end of the second sliding rod slidably connected to the second accommodating cavity, and the second elastic apparatus is in a stretched state.

16. The device fixing bracket according to claim 1, wherein the pull-back structure includes a magnetic apparatus, and the magnetic apparatus has at least one of the following features:
a part of the magnetic apparatus is disposed on the first member, and another part of the magnetic apparatus is disposed on the second member; or
a part of the magnetic apparatus is disposed on the first clamping portion, and another part of the magnetic apparatus is disposed on the second clamping portion.

17. The device fixing bracket according to claim 1, wherein the first member includes a linear guide rail, and the second member includes a sliding table, wherein
the linear guide rail includes a protruding locking strip extending along the target direction, and
the sliding table includes a slot fitting the protruding locking strip to allow the sliding table to be slidably connected to the linear guide rail along the target direction.

18. A vehicle, comprising:
a vehicle body, including a handlebar; and
the device fixing bracket, including:
a first member,
a second member, wherein the first member and the second member are configured to move toward or move away from each other along a target direction,
a first clamping portion, connected to the first member,
a second clamping portion, connected to the second member and disposed opposite to the first clamping portion along the target direction, and
a pull-back structure, connected between the first member and the second member to enable the second clamping portion and the first clamping portion to move toward each other under a pull-back force of the pull-back structure, wherein
when the device fixing bracket is in operation, the second clamping portion and the first clamping portion clamp the target device under the pull-back force, or when the device fixing bracket is not in operation, at least a part of the second member is covered by the first member under the pull-back force, wherein
the first member is mounted in a housing on the handlebar.

19. The vehicle according to claim 18, wherein when the device fixing bracket is in operation, the first clamping portion and the second clamping portion are exposed outside the housing on the handlebar, or when the device fixing bracket is not in operation, the device fixing bracket is hidden in the housing on the handlebar; or
a notch is provided at a joint between the housing on the handlebar and the device fixing bracket to allow the second clamping portion to be stretched along the target direction through the notch.

20. The vehicle according to claim 19, wherein an outer surface of the second clamping portion forms a part of the housing on the handlebar.
